(19) United States
(12) Patent Application Publication
(10) Pub. No.: US 2010/0153241 A1
(43) Pub. Date: Jun. 17, 2010

(54) SYSTEM AND METHOD FOR AUTOMATED RECONCILIATION OF PURCHASE ORDERS

(75) Inventors: Randy Rucker, Houston, TX (US); Lisa Rivers, Katy, TX (US); Brian Lochhead, Houston, TX (US); David Nguyen, Sugar Land, TX (US)

Correspondence Address: HAYNES AND BOONE, LLP;IP Section, 2323 Victory Avenue, Suite 700, Dallas, TX, 75219, US

(73) Assignee: PAYMETRIC, INC., Houston, TX (US)

(21) Appl. No.: 12/333,965

(22) Filed: Dec. 12, 2008

(51) Int. Cl. G06Q 10/00

(52) U.S. Cl. 705/30

(57) ABSTRACT

A system and method for reconciling transaction data, including identifying one or more transactions to be reconciled; aggregating one or more potential matching purchase orders; and creating a proposal that identifies one or more purchase orders that may correlate to the transaction to be reconciled, wherein creating a proposal comprises performing one or more search iterations to identify one or more purchase orders that fit within one or more parameters of the search iterations.

### BACKGROUND OF THE DISCLOSURE

This application claims the benefit of the filing date of U.S. provisional patent application Ser. No. 61/013,818, attorney docket no. 39866.22, filed on Dec. 14, 2007.

Conventional purchase order (“PO”) reconciliation systems generally require a purchase order (PO) number in a merchant reference field of a received invoice in order to automatically reconcile the received invoice with a previously issued PO. For example, a buyer may issue a purchase order to a vendor listing the goods to be purchased, the purchase amount, the payment terms, and any other required information. The buyer will designate a PO number that should be included in an invoice. The vendor will receive the purchase order, and assuming everything is correct, will subsequently ship the goods to the buyer. The vendor, may then send an invoice for the goods to the buyer. The buyer can then use the PO number in the merchant reference field as a key to correlate the received invoice with the PO. However, some vendors for various reasons (e.g. their invoice systems do not support such functionality) do not include the PO number in the merchant reference field in their invoices.

Therefore, conventional reconciliation systems are clearly unable to automatically reconcile invoices without a PO number in the merchant reference field. Alternatively, a purchaser may provide a vendor a purchase order with the purchaser's credit card information. In such a situation, when the vendor ships the goods or performs the services, the vendor can then charge the goods and services to the purchaser's credit card account. The issuing bank of the credit card can then pay the vendor and bill the card account. However, in the daily file of the issuing bank received by the purchaser, the information listed might only include the card number, amount, merchant and date, and once again, because there is no PO number with the transaction, the purchaser may have difficulty reconciling the transaction with a previously issued PO.

The above two types of transactions may be referred to as “level 1” transactions because they do not have a PO number in the merchant reference field. Automatic reconciliation for level 1 transactions may not be possible because of the lack of a PO number in the merchant reference field. Therefore, it would be beneficial to provide conventional reconciliation systems with a method and a system for improving the process of reconciling level 1 transactions.

### SUMMARY OF THE DISCLOSURE

Embodiments of the disclosure may provide a software system used for reconciling PO's and invoices. An exemplary embodiment of the present disclosure introduces a method for reconciling transaction data, including identifying one or more transactions to be reconciled; aggregating one or more potential matching purchase orders; and creating a proposal that identifies one or more purchase orders that may correlate to the transaction to be reconciled; wherein creating a proposal comprises performing one or more search iterations to identify one or more purchase orders that fit within one or more parameters of the search iteration. The one or more parameters may include at least one of following: city comparisons, card number comparisons, merchant to vendor relationship comparisons, date comparisons, or amount comparisons, and each subsequent search iteration may have a broader search criteria than a previous search iteration and a resulting list of purchase orders may be ranked in order from most narrow search parameters to most broad search parameters. The method may further include automatically reconciling the transaction data if only one purchase order meets the one or more parameters.

Embodiments of the invention may further provide a computer program embodied on a computer-usable medium, the medium having stored thereon a sequence of instructions, when executed by a processor, causes the processor to execute a method for reconciling transaction data. The method may include identifying one or more transactions to be reconciled; aggregating one or more potential matching purchase orders; and creating a proposal that identifies one or more purchase orders that may correlate to the transaction to be reconciled; wherein creating a proposal comprises performing one or more search iterations to identify one or more purchase orders that fit within one or more parameters of the search iterations. The search iteration parameters may include at least one of following: city comparisons, card number comparisons, merchant to vendor relationship comparisons, date comparisons, or amount comparisons, and each subsequent search iteration may have a broader search criteria than a previous search iteration and a resulting list of purchase orders may be ranked in order from most narrow search parameters to most broad search parameters. The computer program may further include automatically reconciling the transaction data if only one purchase order meets the one or more parameters.

Embodiments of the invention may further provide a system for reconciling transaction data, including a transaction identification module in communication with a database and configured to identify one or more transactions to be reconciled; a purchase order aggregation module in communication with a database and configured to aggregate one or more potential matching purchase orders; and a proposal module in communication with a database and configured to create a proposal that identifies one or more purchase orders that may correlate to the transaction to be reconciled, wherein creating a proposal comprises performing one or more search iterations to identify one or more purchase orders that fit within one or more parameters of the search iterations. The one or more parameters may include at least one of following: city comparisons, card number comparisons, merchant to vendor relationship comparisons, date comparisons, or amount comparisons, and each subsequent search iteration may have a broader search criteria than a previous search iteration and a resulting list of purchase orders are ranked in order from most narrow search parameters to most broad search parameters. The system may further include automatically reconciling the transaction data if only one purchase order meets the one or more parameters.

Embodiments of the invention may further provide a system for reconciling transaction data, including identifying means for identifying one or more transactions to be reconciled; aggregating means for aggregating one or more potential matching purchase orders; and creating means for creating a proposal that identifies one or more purchase orders that may correlate to the transaction to be reconciled; wherein creating a proposal comprises performing one or more search iterations to identify one or more purchase orders that fit within one or more parameters of the search iterations. The one or more parameters may include at least one of following: city comparisons, card number comparisons, merchant to vendor relationship comparisons, date comparisons, or amount comparisons, and each subsequent search iteration may have a broader search criteria than a previous search iteration and a resulting list of purchase orders are ranked in order from most narrow search parameters to most broad search parameters. The method may further include automatic means for automatically reconciling the transaction data if only one purchase order meets the one or more parameters.

### DESCRIPTION OF THE DRAWINGS

FIG. 1 illustrates a flowchart of an exemplary process for reconciling purchase orders with a transaction.

FIG. 2 schematically illustrates an exemplary embodiment of an enterprise software environment including an exemplary purchase order reconciliation system of the present disclosure.

FIG. 3 schematically illustrates an exemplary embodiment an application communicably coupled to an exemplary purchase order reconciliation system of the present disclosure may create a proposal.

FIG. 4 schematically illustrates an exemplary embodiment of an application communicably coupled to an exemplary purchase order reconciliation system of the present disclosure may perform multiple searches in the matching logic of creating a proposal in FIG. 3.

FIG. 5 schematically illustrates embodiment of an application communicably coupled to an exemplary purchase order reconciliation system of the present disclosure may perform automatic reconciliation of transactions.

### DETAILED DESCRIPTION

Applicants note that the following description references exemplary embodiments of the invention. The invention, however, is not limited to any specifically described embodiment; rather, any combination of the following features and elements, whether related to a described embodiment or not, may be used to implement and/or practice the invention. Moreover, in various embodiments, the invention may provide advantages over the prior art; however, although embodiments of the invention may achieve advantages over other possible solutions and the prior art, whether a particular advantage is achieved by a given embodiment is not intended in any way to limit the scope of the invention. Thus, the following aspects, features, embodiments, and advantages are intended to be merely illustrative of the invention and are not considered elements or limitations of the appended claims; except where explicitly recited in a claim. Similarly, references to “the invention” herein should neither be construed as a generalization of any inventive subject matter disclosed herein nor considered an element or limitation of the appended claims; except where explicitly recited in a claim.

Further, at least one embodiment of the invention may be implemented as a program product for use with a computer system or processor. The program product may define functions of the exemplary embodiments (which may include methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., computer disks for use with a disk drive or hard-disk drive, writable CD-ROM disks and DVD disks, zip disks, portable memory devices, and any other device configured to store digital data); and (iii) information conveyed across communications media, (e.g., a computer, telephone, wired network, or wireless network). These embodiments may include information shared over the Internet or other computer networks. Such computer readable media, when carrying computer-readable instructions that perform methods of the invention, may represent embodiments of the present invention.

Further still, in general, software routines or modules that implement embodiments of the invention may be part of an operating system or part of a specific application, component, program, module, object, or sequence of instructions, such as an executable script. Such software routines typically include a plurality of instructions capable of being performed using a computer system or other type or processor configured to execute instructions from a computer readable medium. Also, programs typically include or interface with variables, data structures, etc. that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

The present disclosure relates generally to reconciling purchase orders (“PO's”) and invoices and/or billing statements in an enterprise software environment. A PO is a commercial document issued by a buyer to a seller, indicating the type, quantities and agreed prices for products or services that the seller will provide to the buyer. PO's also usually specify additional conditions such as terms of payment, terms for liability and freight responsibility, and required delivery date. In the course of the accounts payable process for a business, PO's are matched with transactions including invoices, purchasing card statements and packing slips before the transactions are paid, this process may also be referred to as reconciliation. More specifically, the present disclosure relates to a system used for reconciling PO's and transactions that do not have a PO number in the merchant reference field, which may be referred to as level 1 transactions.

Level 1 transactions are transactions that do not have a PO number in the merchant reference field which links an invoice or a line transaction on a credit card statement with a PO. For example, a PO number might be included on an invoice. The receiving entity can then use the PO number included on the invoice to reconcile the invoice with a transaction. Furthermore, a daily statement from a credit card issuing bank may contain information regarding only the amount, date, merchant and credit card number, but may not provide a purchase order number to reconcile the transaction.

In conventional processes, both manual and automatic, reconciliation for level 1 transactions may not be possible because of the lack of a PO number in the merchant reference field. An exemplary embodiment of the present disclosure may enable automatic reconciliation of level 1 transactions. Further, an embodiment of the present disclosure speeds up user-facilitated reconciliation of level 1 transactions by providing a user with additional information upon which the user can manually make a reconciliation decision.

Applicants note that in describing selected exemplary embodiments of the present disclosure, various objects or components may be implemented as computing modules. These modules may be general-purpose, or they may have dedicated functions such as memory management, program flow, instruction processing, object storage, etc. The modules can be implemented in any way known in the art. For example, in one embodiment a module is implemented in a hardware circuit including custom VLSI circuits or gate arrays, off-the-shelf semiconductors such as logic chips, transistors, or other discrete components. One or more of the modules may also be implemented in programmable hardware devices such as field programmable gate arrays, programmable array logic, programmable logic devices or the like.

In an exemplary embodiment of the disclosure, one or more of the modules are implemented in software for execution by various types of processors. An identified module of executable code may, for instance, include one or more physical or logical blocks of computer instructions that may, for instance, be organized as an object, procedure, or function. Further, the executables of an identified module need not be physically located together, but may include disparate instructions stored in different locations that, when joined logically together, include the module and achieve the stated purpose for the module. A “module” of executable code could be a single instruction, or many instructions, and may be distributed over several different code segments, among different programs, and across several memory devices. Similarly, operational data may be identified and illustrated in association with one or more modules, and may be embodied in any suitable form and organized within any suitable type of data structure. The operational data may be collected as a single data set, or may be distributed over different locations including over different storage devices, and may exist, at least partially, as electronic signals on a system or network.

In some embodiments, higher-level components may be used as modules. For example, one module may include an entire computer acting as a network node. Another module may include of an off-the-shelf or custom program, such as a database management system. These higher-level modules may be decomposable into smaller hardware or software modules corresponding to different parts of a software program and identifiable chips (such as memory chips, ASICs, or a CPU) within a computer.

One type of module is a “network.” A network module defines a communications path between endpoints and may include an arbitrary amount of intermediate modules. A network module may encompass various pieces of hardware, such as cables, routers, and modems, as well as the software necessary to use that hardware. Another network module may encompass system calls or device-specific mechanisms such as shared memory, pipes, or system messaging services. A third network module may use calling conventions within a computing module, such as a computer language or execution environment. Information transmitted using the network module may be carried upon an underlying protocol, such as HTTP, BXXP, or SMTP, or it may define its own transport over TCP/IP, IPX/SPX, Token Ring, ATM, etc. To assure proper transmission, both the underlying protocol as well as the format protocol may split the information into separate pieces, wrap the information in an envelope, or both. Further, a network module may transform the data through the use of one or more computing modules.

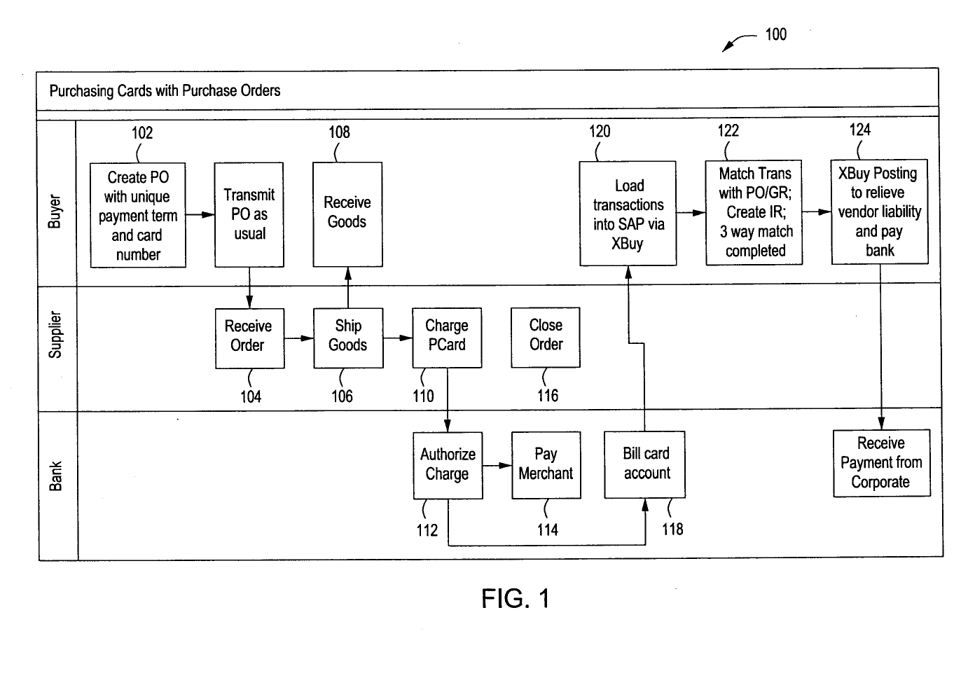

Referring to FIG. 1, an exemplary process 100 of using a purchasing card with a PO and the associated reconciliation is shown. In step 102, a PO is created with a payment term and purchasing card number. The purchasing card and associated purchasing card number may be a credit card issued by American Express, Discover, Master-Card, Visa, or any other credit card issuing bank, for example. The purchase order is transmitted to the supplier in step 104, and the supplier ships the goods in step 106, which are received by the buyer in step 108. After the supplier ships the goods in step 106, the supplier may charge the purchasing card at step 110, and the bank may authorize the charge at step 112. The bank pays the supplier in step 114, referred to as “merchant” in the drawing.

After the bank pays the supplier in step 114, the bank may bill the card account in step 118 and the transaction on the bank's statement may be loaded into an Enterprise Resource Planning (“ERP”) software system, such as products offered by SAP AG, in step 120. Within the ERP, the transaction may be matched with a PO and/or goods receipt (“GR”), an invoice receipt (“IR”) may be created, and the transaction, the PO, and the goods receipt may be correlated via a three way match in step 122. After the three way match in step 122, the transaction is reconciled and the buyer pays the purchase card bank in step 124.

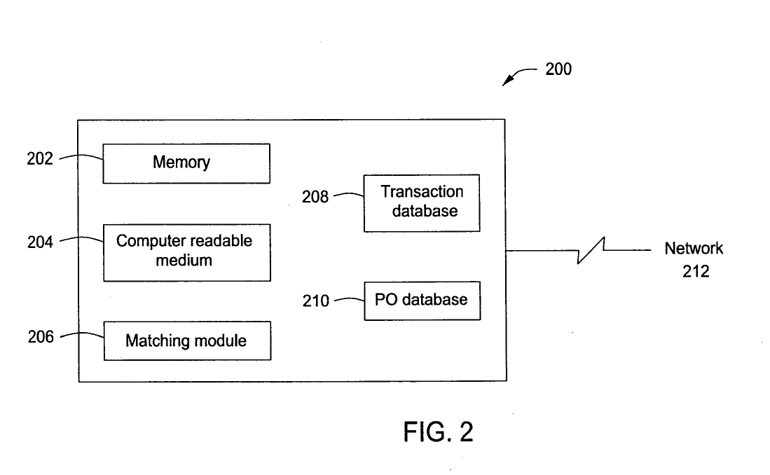

Referring to FIG. 2, illustrated is an exemplary enterprise software environment including an exemplary embodiment of a purchase order system (“POS”) 200 of the present disclosure. The POS 200 includes a memory 202, a computer readable medium 204, a matching module 206, a transaction database 208, and a PO database 210. The POS 200 may be communicably coupled to a network including one or more other systems. In an exemplary embodiment, the POS 200 is communicably coupled to a terminal (not shown). The terminal may include an output device, such as a monitor, and one or more input devices, such as a mouse and/or keyboard. A user may use the terminal to input commands to the POS and the POS 200 may deliver output for display on the terminal.

In another exemplary embodiment, the transaction database 208 of the POS 200 may include records of one or more payment transactions or charges. A transaction may be the electronic record of a charge on a payment card account. A cardholder could be buying a widget over the counter, over the phone, or paying for a PO, or a paying a service invoice. When paying for a PO, the merchant may have multiple transactions/payments for the PO for each shipment. A payment transaction record may include charge data from an invoice, a purchase receipt, a daily file, a statement or any other data related to a transaction. Each record may include transaction data such as purchasing card number, merchant, a predefined merchant to vendor relationship, transaction amount, transaction date, and merchant's city. Merchant information may be provided by a purchasing card statement indicating the merchant account that processed the transaction. Vendor information may be provided from the purchaser and listed on the PO. A predefined merchant to vendor relationship may exist when the merchant listed on the transaction record is directly correlated to a vendor on a PO. This merchant to vendor relationship may be known prior to reconciliation, or the relationship may be derived from a prior transaction with a merchant that was reconciled to a PO with a vendor.

In an exemplary embodiment, a PO database 210 of the POS 200 may include one or more PO's. The PO's may be indexed using a key, such as a PO number, to improve search efficiency. According to an exemplary embodiment, each record may include various information, such as payment terms, PO number, purchasing card number, purchasing organization or group, date created, vendor number, vendor city, total amount, ready to invoice amount, un-invoiced amount, and delivery date.

In an exemplary embodiment, a daily batch process (as is generally known in the art) may import charges and other purchase information into the transactions database 208. As discussed previously, some of these transaction records may lack a PO number in the merchant reference field and it must be determined what PO matches the transaction record. During import, if a transaction appears to be based on a PO, then the transaction may tagged as such. A transaction may be tagged as being based on a PO if, the card is marked for only PO-based transactions, the merchant is linked to a vendor number and the vendor has been identified as a PO Vendor, or a valid PO number is found in the merchant reference field of the transaction. However, even if the transaction is not tagged as being based on a PO, the transaction may still undergo further processing. For example, the first time a merchant is used and therefore there may be no linking of the merchant to a vendor number where the vendor has been identified as a PO Vendor, the transaction may not be tagged as based on a PO, but the transaction would still undergo processing to attempt to match a PO to the transaction because the transaction may have been based on a PO. Further, some purchase cards are used for both PO-based and non-PO-based transactions, and any transaction based on these purchase cards will require further processing as they may have been PO based.

If a valid PO number can be found in the merchant reference field of the transaction record, that PO number is associated to the transaction record. Any transaction not having an associated PO requires further processing. In an exemplary embodiment, a proposal listing one or more candidate POs that may be associated with the transaction record may be created by the matching module 206 of the POS 200.

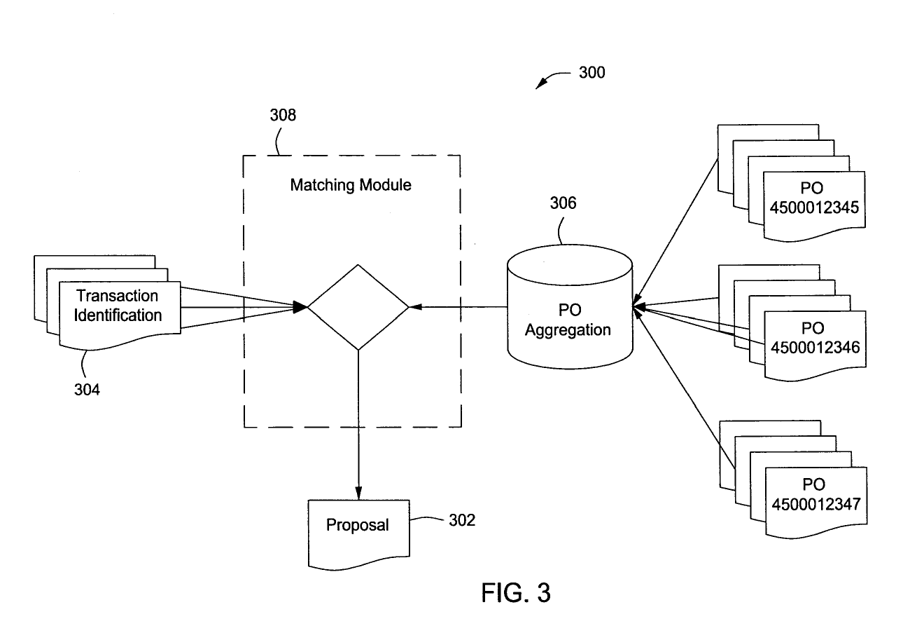

Referring to FIG. 3, in an exemplary embodiment, a method 300 for creating proposals 302 to list one or more PO candidates to be associated with a transaction may include a transaction identification module 304, a PO aggregation module 306, and a matching module 308 for matching PO's to transactions and creating proposals 302.

In an exemplary embodiment, the transaction identification module 304 may receive one or more transaction records from the transaction database 208. A purpose of the transaction identification module 304 may be to determine which transactions need a proposal 302 and output to the matching module 308 those transaction records that need proposals. For example, transactions without a PO number in the merchant reference field may require proposals 302. In an exemplary embodiment, one or more attributes may be associated with each transaction. For example, an “attempt proposal” attribute may be a yes or no value that indicates whether a proposal 302 should be attempted. In an exemplary embodiment, the default attempt proposal attribute value may be yes. According to an exemplary embodiment, if the attempt attribute is yes, then the transaction will undergo the proposal creation process and if the attempt attribute is no, then the transaction will not undergo the proposal creation process. Thus, the attempt attribute is a mechanism for excluding certain transactions from being processed by the proposal creation process. Transactions that were not PO-based may be included in the proposal creation phase.

In an exemplary embodiment, the PO aggregation module 306 is a database that may receive one or more PO's, which may include, without limitation, one or more PO's from the PO database 210. One purpose of the PO aggregation module 306 is to summarize PO history to improve search efficiency. An exemplary embodiment of the PO aggregation module 306 may build a list of PO's to search against and stores the PO's in new tables in the PO database 210. In an exemplary embodiment, only PO's that meet the following conditions are included in the list of PO's: (a) the payment terms of the PO must be purchase card; (b) the PO must have a purchase card number; and (c) the PO must have been created within a defined period of time.

In an exemplary embodiment, the PO aggregation module 306 may create a PO header table and an un-invoiced goods receipts table. In an exemplary embodiment, the PO header table may include the following columns: 1) PO number, 2) purchase card number or internal ID, 3) purchasing organization and group, 4) date created, 5) vendor number, 6) vendor city, 7) total amount, 8) ready-to-invoice amount, and 9) un-invoiced amount. In an exemplary embodiment, the un-invoiced goods receipts table includes the following columns: 1) PO number and 2) goods receipt number, and 3) ready-to-invoice amount.

In an exemplary embodiment, the matching module 308 may receive one or more inputs, including, without limitation, transaction records from the transaction identification module 304 that need a proposal because they do not have a PO number in the merchant reference field. A function of the matching module 308 may be to identify one or more PO's that possibly correlate to a transaction and output this information as a proposal 302. In identifying one or more PO's that may correlate to a transaction, efforts may be made to eliminate a PO from being proposed for multiple transactions. In an exemplary embodiment, these efforts may include ranking the PO's according to how closely the dollar amounts match the transaction, exact dollar amount matches having a higher priority, and multiple search iterations to match PO's to a transaction with expanding or broadening search criteria may also be used, as discussed later. The first search iteration may have very detailed search criteria that may result in a near exact match of the PO to the transaction to allow for automatic reconciling of the transaction without requiring a user to manually approve a PO/transaction match.

In an exemplary embodiment, the matching module 308 may perform one or more search iterations. Each search iteration may return a set of data that includes one or more PO's from the PO aggregation module 306 that may correlate with the transaction. Each search may be bounded by one or more configurable parameters. According to an exemplary embodiment, configurable criteria may include, without limitation, city comparisons (e.g., comparing the merchant's city to the PO's vendor city), date comparisons wherein an exemplary embodiment includes a date range (e.g., comparing the transaction date to expected delivery date(s) or to PO create date), amount comparisons within a certain range, comparing the transaction amount to the total amount, un-invoiced amount, ready-to-invoice amount, goods receipt amount, and whether to include or exclude freight when summing PO amounts.

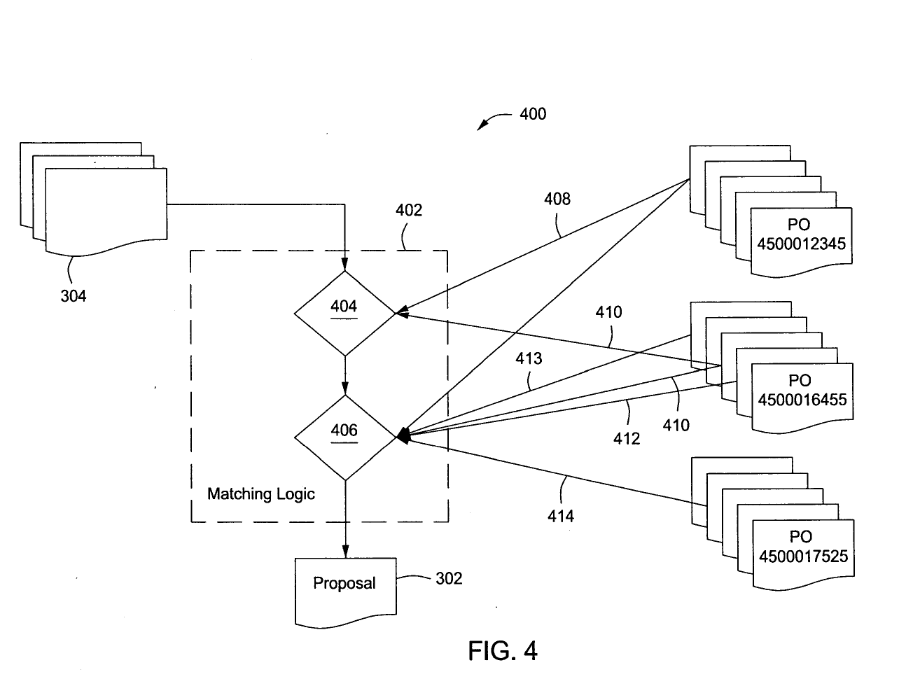

One purpose of having multiple search iterations may be to rank the search results. In an exemplary embodiment, each search may use increasingly broader search parameters than the previous search. For example, referring to FIG. 4, in an exemplary embodiment, matching logic 402 may include a first pass 404 and a second pass 406. In first pass 404, the configurable criteria may include to match the city, match the delivery date, and no range on the amount comparison. First pass 404 may find purchase order 408 and purchase order 410 that match this search criteria. In second pass 406, the search criteria may be broadened versus first pass 404, and might include PO's that match the creation date of the purchase order to the transaction date and a 3% range on the amount comparison between the PO's and the transaction. Second pass 406 may then find the purchase orders 408 and 410, and purchase orders 412, 413 and 414. The resulting list of PO's may be stored as a proposal 302 associated with the transaction and the resulting list of PO's in the proposal 302 may receive a ranking with purchase orders 408 and 410 ranked higher than purchase orders 412, 413 and 414.

Further, the matching module 308 may include one or more configurable options. In an exemplary embodiment, configurable options may include, without limitation, 1) auto-accept (i.e. automatically accept the proposal if only one matching PO is found), 2) freight considerations (e.g., including/excluding freight when summing PO amounts), and 3) variable amount ranges (e.g., defining a percentage range above and/or below the transaction amount).

In an exemplary embodiment, PO's and transactions may be reconciled either automatically or manually. In an exemplary embodiment of manual reconciliation, a proposal 302, such as the proposal 302, may be tied to a transaction that does not have a PO number in the merchant reference field as discussed above. The proposal 302 may then be displayed to a user, the user may then individually accept a proposal 302 by accepting and matching a PO within the proposal 302 to a transaction. In an exemplary embodiment, the user may view the PO's within the proposal 302 and the various amounts, dates, etc., pertaining to each PO, that may be used in the matching module 308. The user may also be able to view what other transactions have the same PO included on their proposals and may have facilitated acceptance. In an exemplary embodiment, a user may accept or decline multiple proposals 302 at a time. In an exemplary embodiment, accepting a proposal 302 associates a single PO to the transaction, and physically deletes the attached proposal.

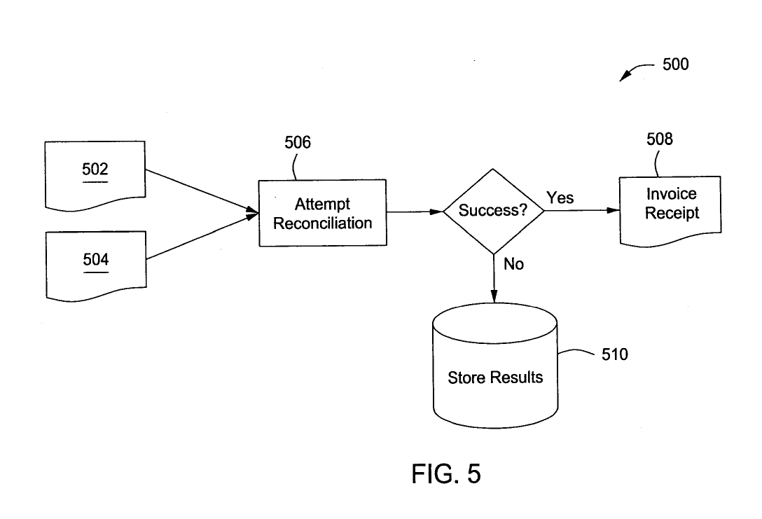

Referring to FIG. 5, an exemplary embodiment of automatic reconciliation 500 is illustrated. According to an exemplary embodiment, transactions 502 and 504 each may have a single associated PO. Reconciliation may be attempted at a step 506 for each transaction, and if the reconciliation is successful, an invoice receipt may be generated at a step 508, and if the reconciliation is unsuccessful, the results may be stored with the transaction at a step 510.

Once a PO is accepted as matching a transaction then a new merchant to vendor relationship may be created, and this relationship may then be used to help associate other POs with remaining transactions. The manner of usage and operation of the present disclosure should be apparent to one of ordinary skill having the benefit of the present disclosure. The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

In view of the above and the figures, it should be apparent to those skilled in the art that the present disclosure introduces a method for reconciling transaction data, including identifying one or more transactions to be reconciled; aggregating one or more potential matching purchase orders; and creating a proposal that identifies one or more purchase orders that may correlate to the transaction to be reconciled; wherein creating a proposal comprises performing one or more search iterations to identify one or more purchase orders that fit within the search iteration parameters. The search iteration parameters may include at least one of following: city comparisons, card number comparisons, merchant to vendor relationship comparisons, date comparisons, or amount comparisons, and each subsequent search iteration may have a broader search criteria than the previous search iteration and the resulting list of purchase orders may be ranked in order from most narrow search parameters to most broad search parameters. The method may further include automatically reconciling the transaction data if only one purchase order meets the designated search criteria.

The systems and methods disclosed and claimed herein can be made and executed without undue experimentation in light of the present disclosure. While the systems and methods of this invention have been described in terms of embodiments, it will be apparent to those of skill in the art that variations may be applied to the systems and in the steps or in the sequence of steps of the methods described herein without departing from the concept, spirit and scope of the invention. Further, since numerous modifications and changes will readily occur to those skilled in the art, it is not desired to limit the invention to the exact construction and operation shown and described, and accordingly, all such similar substitutes and modifications apparent to those skilled in the art are deemed to be within the scope and concept of the invention.

Although the present disclosure has described embodiments relating to specific networked enterprise environments, it is understood that the apparatus, systems and methods described herein could applied to other environments.

Any spatial references used herein, such as, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above. Additionally, in several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

What is claimed is:

1. A method for reconciling transaction data, comprising:
identifying one or more transactions to be reconciled;
aggregating one or more potential matching purchase orders; and
creating a proposal that identifies one or more purchase orders that likely correlate to the transaction to be reconciled;
wherein creating a proposal comprises performing one or more search iterations to identify one or more purchase orders that fit within one or more parameters of the search iterations.

2. The method of claim 1, wherein the one or more parameters include at least one of city comparisons, card number comparisons, merchant to vendor relationship comparisons, date comparisons, or amount comparisons.

3. The method of claim 1, wherein each subsequent search iteration has broader parameters than a previous search iteration and a resulting list of one or more purchase orders are ranked in order from most narrow search parameters to most broad search parameters.

4. The method of claim 1, further comprising automatically reconciling the transaction data if only one purchase order meets the one or more parameters.

5. A computer program embodied on a computer-usable medium, the medium having stored thereon a sequence of instructions, when executed by a processor, causes the processor to execute a method for reconciling transaction data, comprising:
identifying one or more transactions to be reconciled;
aggregating one or more potential matching purchase orders; and
creating a proposal that identifies one or more purchase orders that may correlate to the transaction to be reconciled;
wherein creating a proposal comprises performing one or more search iterations to identify one or more purchase orders that fit within one or more parameters of the search iterations.

6. The method of claim 5, wherein the one or more parameters include at least one of city comparisons, card number comparisons, merchant to vendor relationship comparisons, date comparisons, or amount comparisons.

7. The method of claim 5, wherein each subsequent search iteration has broader parameters than a previous search iteration and a resulting list of purchase orders are ranked in order from most narrow search parameters to most broad search parameters.

8. The method of claim 5, further comprising automatically reconciling the transaction data if only one purchase order meets the one or more parameters.

9. A system for reconciling transaction data, comprising:
a transaction identification module in communication with a database and configured to identify one or more transactions to be reconciled;
a purchase order aggregation module in communication with a database and configured to aggregate one or more potential matching purchase orders; and
a proposal module in communication with a database and configured to create a proposal that identifies one or more purchase orders that may correlate to the transaction to be reconciled;
wherein creating a proposal comprises performing one or more search iterations to identify one or more purchase orders that fit within one or more parameters of the search iterations.

10. The system of claim 9, wherein the one or more parameters include at least one of city comparisons, card number comparisons, merchant to vendor relationship comparisons, date comparisons, or amount comparisons.

11. The system of claim 9, wherein each subsequent search iteration has broader parameters than a previous search iteration and a resulting list of purchase orders are ranked in order from most narrow search parameters to most broad search parameters.

12. The system of claim 9, further comprising automatically reconciling the transaction data if only one purchase order meets the one or more parameters.

13. A system for reconciling transaction data, comprising:
identifying means for identifying one or more transactions to be reconciled;
aggregating means for aggregating one or more potential matching purchase orders; and
creating means for creating a proposal that identifies one or more purchase orders that may correlate to the transaction to be reconciled;
wherein creating a proposal comprises performing one or more search iterations to identify one or more purchase orders that fit within one or more parameters of the search iterations.

14. The system of claim 13, wherein the one or more parameters include at least one of city comparisons, card number comparisons, merchant to vendor relationship comparisons, date comparisons, or amount comparisons.

15. The method of claim 13, wherein each subsequent search iteration has broader parameters than a previous search iteration and a resulting list of purchase orders are ranked in order from most narrow search parameters to most broad search parameters.

16. The method of claim 13, further comprising automatic means for automatically reconciling the transaction data if only one purchase order meets the one or more parameters.
